(19) United States
(12) Patent Application Publication
(10) Pub. No.: US 2006/0075572 A1
(43) Pub. Date: Apr. 13, 2006

(54) Multi-functional firefighter's tool

(76) Inventor: Danny Young, Charlottetown (CA)

Correspondence Address: DENNISON, SCHULTZ, DOUGHERTY & MACDONALD, 1727 KING STREET, SUITE 105, ALEXANDRIA, VA, 22314, US

(21) Appl. No.: 11/225,012

(22) Filed: Sep. 14, 2005

(30) Foreign Application Priority Data
Oct. 12, 2004 (CA) 2,484,369

(51) Int. Cl. B25F 1/00; B25B 13/00; B66F 15/00

(52) U.S. Cl. 7/138; 7/158; 7/166

(57) ABSTRACT

A multifunctional firefighter's tool has a head mounted on an elongated handle which is covered with an electrical and thermal insulator to minimize the occurrence of heat and electrical shocks to the user. An axe blade with a polygonal aperture sized to engage a typical gas valve is formed on one side of the head, the aperture having small bulbous cutouts at the vertices of the polygon. A cutout which is shaped as the mouth of a wrench is also formed at an edge of the head, the mouth defining two stepped surfaces to provide a multi-sized wrench. A spanner wrench sized for coupling and decoupling water hoses is formed on the other side of the head relative to the longitudinal axis of the handle, the spanner wrench being defined by a pry bar portion and a hook portion formed at an appropriate distance from the pry bar portion.

### BACKGROUND OF THE INVENTION

The present invention relates to a firefighter's tool, and more particularly to a combination firefighter's tool combining the function of an axe, a spanner wrench for coupling and decoupling hoses, a pry bar and a hydrant valve wrench.

It is well known that in most fire incidents, fire cannot be controlled form the outside and firefighters are forced to enter fire sites to rescue victims and shut down the fire from the source, especially in residential areas. Because of the need to open water hydrants and couple water hoses, break into a house or cut an object, a variety of tool may be needed. This need has already been addressed as evidenced by the patent literature.

U.S. Pat. No. 3,599,255 describes a combination tool having an insulated handle and a head with an aperture for opening a hydrant valve. The head also has a cutting edge, a pry bar and a nail puller notch. On the opposite end of the handle, the tool has a wrecking bar head.

Canadian Patent 1,241,154 describes a tool that has a handle and a head, the latter having projections shaped to form a spanner wrench for coupling and decoupling hoses.

Canadian Patent 1,141,107 describes a combination tool composed of two pivotally connected elongate handle members, having an axe head and pick head mounted respectively thereon. The axe head defines a blade and a pentagonal aperture formed centrally within the axe head to receive a fire-hydrant shut off valve.

U.S. Pat. No. 6,568,016 teaches a firefighter's implement specifically designed to facilitate sweeping floor surfaces when searching in low visibility conditions.

Canadian Patent Application 2,296,048 describes a multi-functional axe having an elongated handle, a pry bar that can be used for tearing off nails, and an axe head having at one side a blade and a squared aperture for receiving fire hydrant valves, and on the second side a pick and a hook for opening/closing a water hose.

While the designs taught by the above-named references are useful, an alternative firefighter's tool has been devised and is described hereinbelow.

### SUMMARY OF THE INVENTION

An object of the invention is accordingly to provide an improved firefighter's tool.

A multi-functional firefighter's tool according to the present invention comprises:

an elongated handle defining a longitudinal axis,

a tool head mounted at a first end of the handle, the head comprising
a polygonal aperture sized to receive a water hydrant stem, having a number of vortices, with a cutout at each vortex to accommodate any machining inaccuracies of a matching polygonal stem of the hydrant, and
a cutting edge formed along one side of the head relative to the longitudinal axis.

Preferably the tool may also include one or more of the following:
a pry bar formed on the tool head on the opposite side of the longitudinal axis relative to the cutting edge and extending substantially perpendicularly to the longitudinal axis,
a hook portion formed on the tool head in the vicinity of the pry bar and shaped to form a spanner wrench in conjunction with the pry bar, and
a cutout shaped as a multi-size nut wrench, the cutout having two opposite stepped surfaces, and
a rigid pry bar provided on the second end of the handle, having a V shaped opening therein, for pulling-off nails of multiple sizes.

Preferably, the handle is at least partially wrapped with a heat-insulating and electrically insulating material such as plastic or caoutchouc.

### BRIEF DESCRIPTION OF THE DRAWINGS

An example of preferred embodiments of the invention will now be described with reference to the accompanying drawing, in which:

FIG. 1 is a top plan view of an embodiment of the multi-functional firefighter's tool.

### DETAILED DESCRIPTION

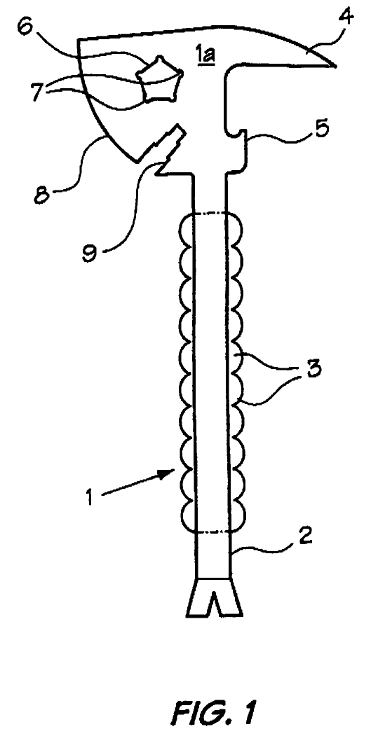

We refer now to FIG. 1 which illustrates an embodiment of the multi-functional firefighter's tool 1 of the present invention. As illustrated in FIG. 1, the tool has a handle 2 which is covered with an insulating material 3 to minimize to the user the occurrence of heat and electrical shocks which are often encountered at fire sites. The insulator cover could be made out of plastic, caoutchouc, wood etc., and it is designed to provide a good grip so that the handle does not easily slip away from the user's hand.

Mounted on one end of the handle is a tool head 1a which has several features. A pointed end member 4 is formed to extend substantially perpendicularly to the handle and can be used as a pry bar to break a lock or a window, to disconnect electrical wires causing fire or to avoid additional sources of fire caused by the contact of electrical wires with different polarities when overheated. The pointed member 4 could help the firefighter climbing broken stairs, a roof or the like. A hook 5 is formed in the tool head at a predetermined distance from the member 4. When combined with the hook 5, the pointed end member 4 can be used as a hose coupler to couple and uncouple hoses to hydrants.

Formed in the head also is a polygonal aperture 6 having small bulbous cutouts, or cavities 7 provided at the vertex of each two segments of the polygon, to facilitate the coupling of the aperture to the nut, or stem of the valve, which often has burrs, bosses or overflows at the intersections of two sides, due to machining inaccuracies. Thus, while a rusty or hot nut may not fit in a standard fixed wrench, an aperture having the structure described in the present invention may be the solution.

On the other side of the member 4, a sharp edge 8 is made for breaking a door or cutting wires or cables, and in the vicinity of the edge 8, there is made a squared multiple-size nut removal opening 9 capable of removing nuts of different sizes, so that the biggest size fits at the entrance of the opening and the smallest at the end, respectively.

On the other end of the handle, there is provided a rigid pry bar, having a V shaped opening therein, for pulling-off nails of multiple sizes.

The multi-functional firefighter's tool with its different applications described above, replaces many other tools and is relatively lightweight and easy to be carried e.g. by wearing a belt having a special housing holster for the axe head. The tool could be made of stainless steel or any other material which is lightweight and rigid at the same time.

While the multi-functional firefighter's tool is described above in terms of its use in fire incidents, it is intended that the device can also be used in rescuing car accident victims by prying off windshields, breaking glass and opening doors. It can also be used in carpentry and car body shops.

The present invention has been described herein in detail with reference to the preferred embodiments thereof, although further modifications and variations are possible within the spirit and scope of the invention.

1. A multi-functional firefighter's tool comprising:
an elongated handle defining a longitudinal axis,
a tool head mounted at a first end of the handle, the head comprising:
a polygonal aperture sized to receive a water hydrant stem, having a number of vortices, with a cutout at each vortex to accommodate any machining inaccuracies of a matching polygonal stem of the hydrant, and
a cutting edge formed along one side of the head relative to the longitudinal axis.

2. A multi-functional firefighter's tool according to claim 1, further including a first pry bar formed on the tool head on the opposite side of the longitudinal axis relative to the cutting edge and extending substantially perpendicularly to the longitudinal axis.

3. A multi-functional firefighter's tool according to claim 1, further including a hook portion formed on the tool head in the vicinity of the pry bar and shaped to form a spanner wrench in conjunction with the first pry bar.

4. A multi-functional firefighter's tool according to claim 2, further including a hook portion formed on the tool head in the vicinity of the pry bar and shaped to form a spanner wrench in conjunction with the first pry bar.

5. A multi-functional firefighter's tool according to claim 1, further including a cutout shaped as a multi-size nut wrench, the cutout having two opposite stepped surfaces.

6. A multi-functional firefighter's tool according to claim 2, further including a cutout shaped as a multi-size nut wrench, the cutout having two opposite stepped surfaces.

7. A multi-functional firefighter's tool according to claim 3, further including a cutout shaped as a multi-size nut wrench, the cutout having two opposite stepped surfaces.

8. A multi-functional firefighter' tool according to claim 1, further including a second pry bar which is provided on the second end of the handle.

9. A multi-functional firefighter' tool according to claim 2, further including a second pry bar which is provided on the second end of the handle.

10. A multi-functional firefighter' tool according to claim 3, further including a second pry bar which is provided on the second end of the handle.

11. A multi-functional firefighter' tool according to claim 5, further including a second pry bar which is provided on the second end of the handle.

12. A multi-functional firefighter's tool according to claim 8, wherein the second pry bar includes a V shaped opening therein, for pulling-off nails of multiple sizes.

13. A multi-functional firefighter's tool according to claim 9, wherein the second pry bar includes a V shaped opening therein, for pulling-off nails of multiple sizes.

14. A multi-functional firefighter's tool according to claim 10, wherein the second pry bar includes a V shaped opening therein, for pulling-off nails of multiple sizes.

15. A multifunctional firefighter's tool according to claim 1, wherein the handle is at least partially wrapped with an insulating material for minimizing heat-insulating and electrically insulating material for minimizing occurrence of heat and electrical shocks.

16. A multi-functional firefighter's tool according to claim 2, wherein the handle is at least partially wrapped with an insulating material for minimizing heat-insulating and electrically insulating material for minimizing occurrence of heat and electrical shocks.

17. A multi-functional firefighter's tool according to claim 3, wherein the handle is at least partially wrapped with an insulating material for minimizing heat-insulating and electrically insulating material for minimizing occurrence of heat and electrical shocks.

18. A multi-functional firefighter's tool according to claim 5, wherein the handle is at least partially wrapped with an insulating material for minimizing heat-insulating and electrically insulating material for minimizing occurrence of heat and electrical shocks.

19. A multi-functional firefighter's tool according to claim 8, wherein the handle is at least partially wrapped with an insulating material for minimizing heat-insulating and electrically insulating material for minimizing occurrence of heat and electrical shocks.

20. A multi-functional firefighter's tool according to claim 12, wherein the handle is at least partially wrapped with an insulating material for minimizing heat-insulating and electrically insulating material for minimizing occurrence of heat and electrical shocks.
